(19) United States
(12) Patent Application Publication
(10) Pub. No.: US 2021/0343137 A1
(43) Pub. Date: Nov. 4, 2021

(54) Portable Accessory Device for User Protection

(71) Applicant: Samantha Santiago, Opelika, AL (US)

(72) Inventor: Samantha Santiago, Opelika, AL (US)

(21) Appl. No.: 16/863,281

(22) Filed: Apr. 30, 2020

(51) Int. Cl. G08B 25/01; G08B 21/02; G08B 29/08; H04W 4/029; H04W 4/90; G04G 21/04; G06F 1/16

(52) U.S. Cl. CPC G08B 25/016; G08B 21/02; G08B 29/08; G06F 1/163; H04W 4/90; G04G 21/04; G06F 1/1656; H04W 4/029

(57) ABSTRACT

A portable accessory to track a wearer from a mobile application or allow the wearer to alert someone when they are in danger. The portable accessory includes a housing unit having a waterproof speaker, a global position system tracking chip and an emergency response beacon. The portable accessory also has a set of straps made of a tear-proof material and a combination lock. A continuous wire is included within the set of straps to form a complete circuit that runs through the housing unit and two straps when the set of straps are coupled together.

### FIELD

The exemplary embodiments describe a portable accessory, and more specifically a piece of portable technology that may include a GPS chip, speaker with a siren and depressible crown wheel that allows a wearer or a person with the wearer's band information to track the wearer of the band from a mobile application or allow the wearer to alert someone when they are in danger.

### BACKGROUND INFORMATION

There are a number of different portable technology devices used by the general public today. A majority of these devices can be freely removed by anyone, whether it be the person wearing the device or a third party choosing to remove the device. Because of this, devices used to track adults and/or children could be easily removed by an assailant rendering the portable technology moot in an emergency situation. Additionally, the portable technology devices often need to be used in tandem with a mobile device to have all features available to the wearer.

### SUMMARY

In an exemplary embodiment described herein, a portable accessory made up of a housing that contains a GPS chip, waterproof speaker, emergency response beacon and depressible crown wheel. Furthermore, the housing is configured to attach to the wearer through the use of a set of straps in which one strap contains a combination lock that the other strap is configured to lock in to, thus allowing the portable accessory to be unremovable by anyone without the code to unlock the combination lock.

### BRIEF DESCRIPTION OF THE DRAWINGS

FIGS. 1A and 1B show a top view of an exemplary embodiment of a portable accessory with a housing unit exterior configured as a watch face.

FIG. 2A and FIG. 2B show a top view of an exemplary embodiment of a portable accessory with a housing unit exterior configured as an engravable faceplate.

FIG. 3 shows a combination lock on a set of straps of the portable accessory and an exemplary manner of locking the straps together.

FIG. 4 shows an exemplary embodiment of the combination lock on the set of straps of the portable accessory configured to adjust the length of one of the straps by folding it into the combination lock.

FIG. 5 shows an exemplary embodiment of the combination lock on the set of straps of the portable accessory configured to adjust the length of one of the straps through the use of an additional strap and locking mechanism configured to lock into the combination lock.

FIG. 6 shows an exemplary embodiment of the combination lock on the set of straps of the portable accessory configured to adjust the length of one of the straps through the use of an interior buckle inside the combination lock.

FIG. 7 shows a functional view of an interior of the housing unit of the portable accessory according to various exemplary embodiments.

### DETAILED DESCRIPTION

The exemplary embodiments may be further understood with reference to the following description and the related appended drawings, wherein like elements are provided with the same reference numerals. The exemplary embodiments describe a portable accessory, which includes a housing unit, a plurality of straps with a combination lock and a continuous wire running throughout the portable accessory. The housing unit may include a global positioning satellite (GPS) chip, a waterproof speaker and a depressible crown wheel.

The outer anterior surface of the housing unit may be configured such that it may be a watch face or an engravable faceplate. The exemplary embodiments may be a portable accessory configured to be worn by the user on either of the user's wrists. The exemplary embodiments are also configured to be used with a mobile application corresponding to a unique identification number of the portable accessory. This unique identification number is configured to be used with a mobile application.

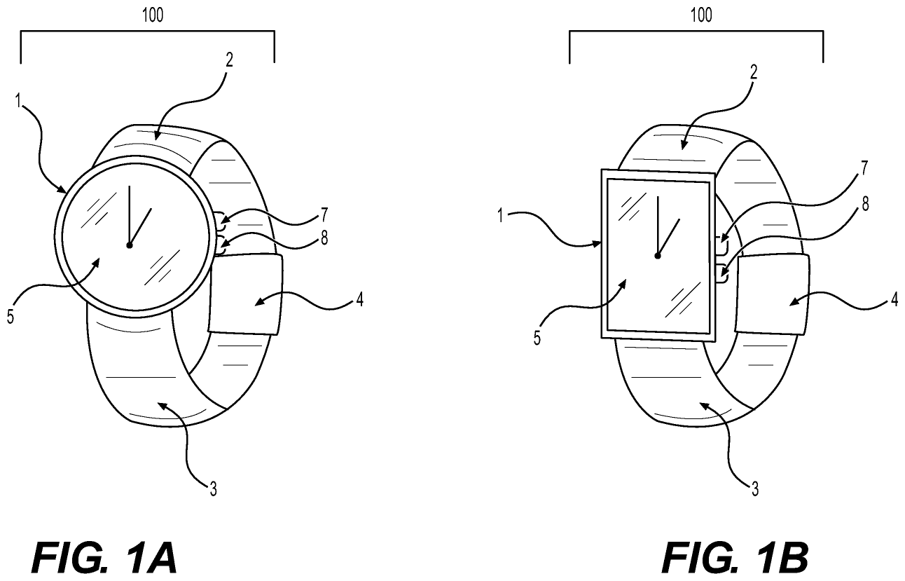

FIGS. 1A and 1B show a top view of an exemplary embodiment of a portable accessory 100 with a housing unit 1 exterior configured as a watch face 5 according to the exemplary embodiments described herein. FIG. 1A and FIG. 1B show the exterior of housing unit 1 as a watch face 5. The watch face 5 is configured to be either analog or digital. The housing unit 1 is further configured to be any shape and there is no requirement as to what the shape can be. FIG. 1B depicts the housing unit 1 as a rectangle. FIG. 1A and FIG. 1B shows the placement of the depressible crown wheel 8. The depressible crown wheel 8 is coupled to an anterior lateral side of housing unit 1. The secondary crown wheel 7 is coupled to the same anterior lateral side of housing unit 1 as the depressible crown wheel 8. The secondary crown wheel 7 may be coupled to housing unit 1 superior or inferior to the depressible crown wheel 8. The secondary crown wheel 7 is configured to allow the user to change the time displayed on the watch face.

FIG. 1A and FIG. 1B further shows the placement of the set of straps 2 and 3. The housing unit 1 is configured with two straps and such that a first end of a first strap 2 is attached to a first side of the housing unit and a first end of a second strap 3 is attached to a second side of the housing unit 1 opposite the first side. A second end of the first strap 2 is configured such that it is a combination lock 4 or a mechanism to be locked into a combination lock, while a second end of the second strap 3 is configured such that it has the corresponding mechanism to the first strap, e.g., the combination lock 4 or locking mechanism. In this example, the combination lock 4 is coupled to one end of the first strap 2 while the other end of the first strap is coupled to the first side of housing unit 1. Furthermore, one end of the second strap 3 is coupled to the second opposite side of housing unit 1 while the opposite end of the second strap 3 is configured to lock into the combination lock 4. The first strap 2 will also be configured such that there are small evenly spaced holes, similar to what one would find on the strap of a watch, that are used to lock the first strap 2 into the combination lock 4. The combination lock 4 is configured such that a small convex protrusion is coupled to an interior surface of the combination lock 4 allowing the small evenly spaced holes on the first strap 2 to fit onto the small convex protrusion when combination lock 4 is closed. The combination lock 4 may be configured such that the dials of the combination can be on any of the exterior surfaces of combination lock 4. The combination lock 4 may be a mixture of digits and may include a minimum of 2 dials on the combination lock 4. An ordinary person skilled in the art of wearable technology would be aware that the combination dials could be placed on any of the exterior surfaces of the combination lock 4.

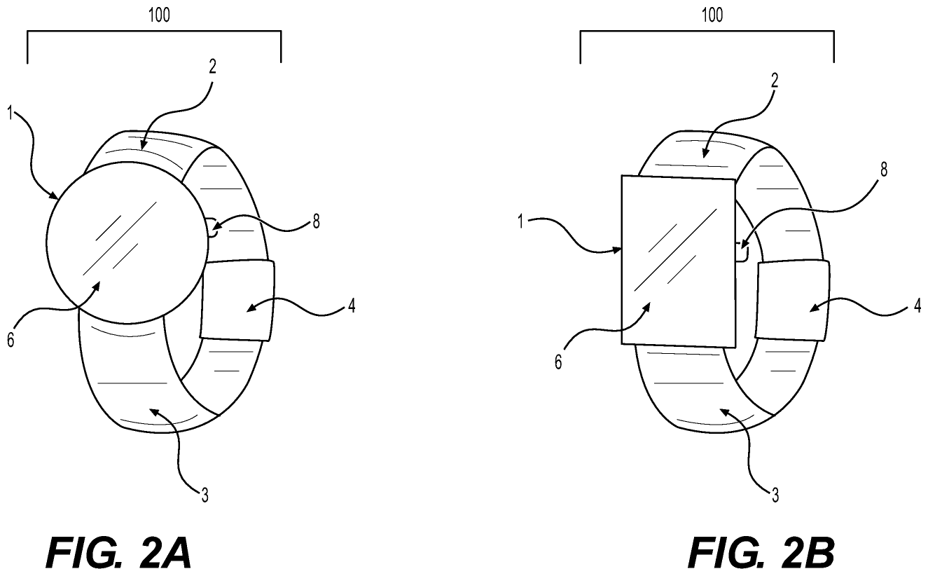

FIG. 2A and FIG. 2B show a top view of an exemplary embodiment of a portable accessory 100 with a housing unit 1 exterior configured as an engravable faceplate 6 according to the exemplary embodiments described herein. The configuration of the straps in FIG. 2A and FIG. 2B are the same configuration as described and shown in FIG. 1A and FIG. 1B. FIG. 2A and FIG. 2B show the exterior anterior surface of housing unit 1 as an engravable face plate 6. The engravable face place 6 is configured to be engraved with any combination of words or numbers as a person sees fit. The engravable faceplate 6 is further configured to be any shape and there is no requirement as to what shape it can be. FIG. 2A depicts the engravable faceplate 6 as circular and FIG. 2B depicts the engravable faceplate 6 as rectangular. The depressible crown wheel 8 is coupled to an anterior lateral side of housing unit 1 as depicted in FIG. 2A and FIG. 2B.

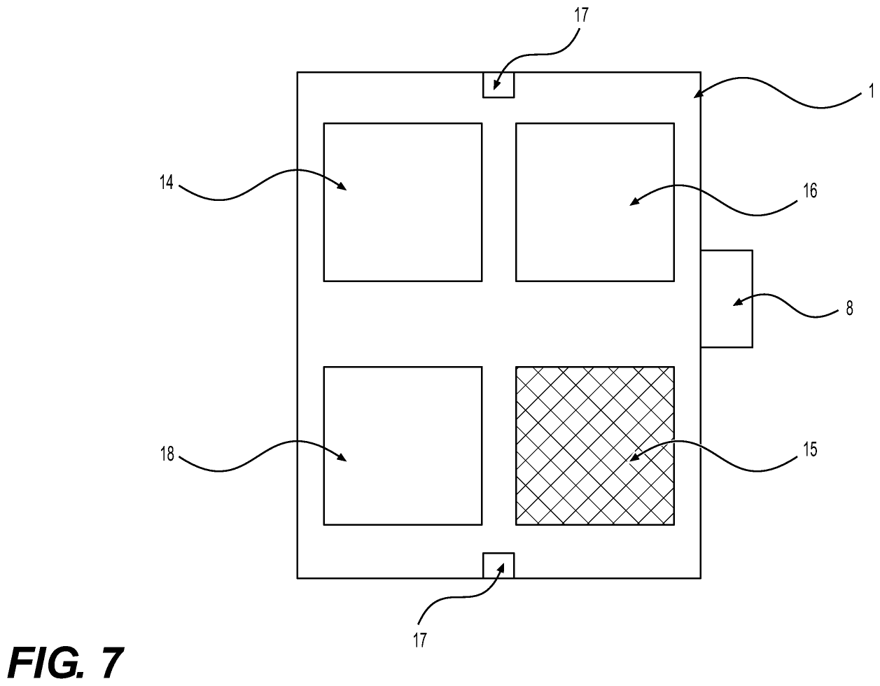

FIG. 7 shows a functional view of an interior of the housing unit 1 of the portable accessory 100 according to various exemplary embodiments. The interior of the housing unit 1 may include a GPS chip 14, a waterproof speaker 15, an emergency response beacon 16 and a portion of the depressible crown wheel 8. The housing unit 1 as a whole is designed to be waterproof at a deep-sea diving level, which means it is configured to attain an ISO 6425 certification. The housing unit 1 is configured to be any shape and there is no requirement as to what the shape can be. Furthermore, each of the items located in the interior of the housing unit 1 are configured to be any shape and there is no requirement as to what shape that can be. Additionally, this certification would extend to the waterproof speaker 15, emergency response beacon 16 and GPS chip 14 contained on the interior of the housing unit 1 and the depressible crown wheel 8 contained on a third side of the exterior of the housing unit 1. The waterproof speaker 15 is configured to emit a siren when the portable accessory 100 is activated through the use of the mobile application account associated with the portable accessory's unique identification number. The waterproof speaker 15 is further configured to emit a siren when someone attempts to tamper with or destroy in any way the portable accessory 100. The emergency beacon 16 may be configured to be a cellular chip (or any other type of wireless chip) that emits signals that can be received by other devices either directly (e.g., peer-to-peer) or indirectly through a network. The emergency beacon 16 is further configured to be activated when the depressible crown wheel 8 is depressed or through the use of the mobile application account associated with a unique identification number of the portable accessory 100. The emergency beacon 16 is further configured to be activated when the portable accessory 100 is tampered with or destroyed in any way. The GPS chip 14 is configured to be activated through the depression of the crown wheel 8 or through the use of the mobile application associated with the unique identification number of the portable accessory 100. The GPS chip 14 is further configured to be activated in the event that the portable accessory is tampered with or destroyed in any way. The GPS chip 14 may be further configured to allow continuous location tracking or tracking only when activated in the manners described above. A person skilled in the art of wearable technology would be aware that the items located on the interior of the housing unit 1 may be arranged in any manner. A person skilled in the art of wearable technology would further be aware that the items located on the interior of the housing unit 1 may be configured in any shape necessary. FIG. 7 depicts all the items located on the interior as rectangles, but there is no shape requirement.

FIG. 7 further shows that the interior of the housing unit 1 is configured to include part of the continuous wire 17 and the power source 18 for the portable accessory 100. The portable accessory 100 may have a power source 18 that includes, for example, a rechargeable battery, an automatic chronograph battery, etc. A person skilled in the art of wearable technology would be aware of what these various power sources are or could be. The continuous wire 17 in the housing unit 1 is configured to run through the set of straps 2 and 3 for a circuit to be completed once the straps 2 and 3 are locked together through the combination lock 4. The continuous wire 17 is further configured to start at one end on the interior of the housing unit 1, run through the straps 2 and 3 to form a complete circuit when the straps 2 and 3 are locked together and finally terminate at a second end on the interior of the housing unit 1. Any attachments to any of the straps 2 and 3 are also configured to allow the continuous wire 17 to go through and create a complete circuit upon locking the straps 2 and 3 through the combination lock 4. A person skilled in the art of wearable technology would be aware that the continuous wire 17 can be configured in other ways in the interior of the housing unit. The continuous wire 17 points shown in FIG. 7 is just one exemplary embodiment of the continuous wire 17 on the interior of the housing unit 1.

As described above and as will be described further below, the portable accessory 100 may be associated with a mobile application. One or more portions of the mobile application may be executed on the portable accessory 100. These portions of the mobile application may be executed by the emergency beacon 16 or there may be a separate application processor that may also be included in the housing unit 1 to execute the mobile application.

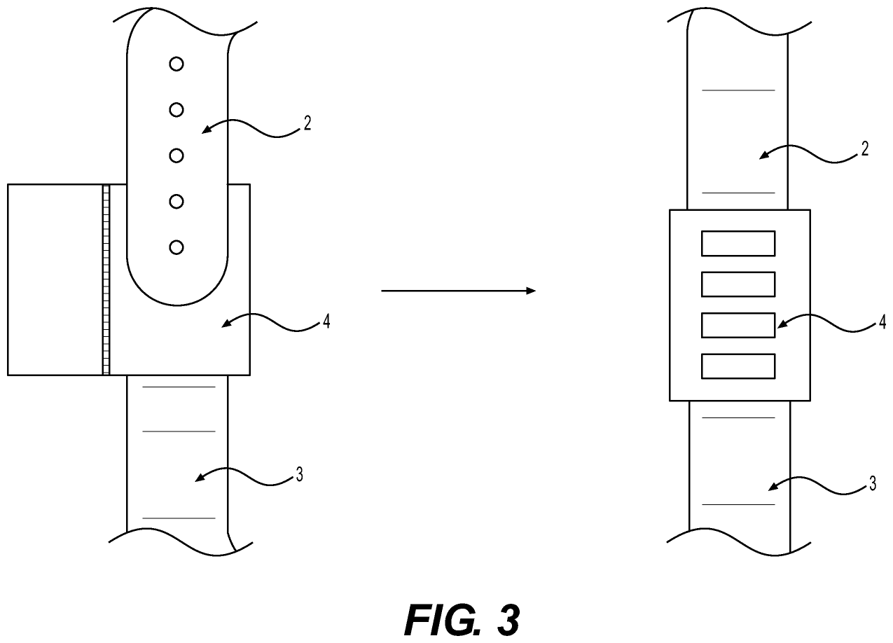

FIG. 3 shows a combination lock 4 on a set of straps 2 and 3 of the portable accessory 100 and an exemplary manner of locking the straps 2 and 3 together. The left portion of FIG. 3 shows how straps 2 and 3 are configured when the combination lock 4 is open. The combination lock 4 is coupled to the strap 3 and is configured to receive one end of the strap 2. The right portion of FIG. 3 shows the straps 2 and 3 when the combination lock 4 is closed. The end of the strap 2 is locked inside of the combination lock 4 and cannot be removed without entering the combination for the combination lock 4. The combination lock 4 may be a mixture of digits and may include a minimum of 2 dials on the combination lock 4. When the straps 2 and 3 are locked together with combination lock 4, this configures the continuous wire contained in both straps 2 and 3 to be a complete circuit. The continuous wire is coupled to the interior of straps 2 and 3 and runs to and from the housing unit 1 through straps 2 and 3. When the circuit is complete, the straps 2 and 3 and housing unit 1 cannot be tampered with or destroyed in any way without an alert being sent out. The continuous wire 17 is configured such that the waterproof speaker 14 and siren would be activated if the straps 2 and 3 or housing unit 1 were tampered with or destroyed. Furthermore, tampering with or destroying the straps 2 and 3 or the housing unit 1 is configured to emit a signal to the mobile application associated with the unique identification number of the portable accessory 100. In turn, this would notify another that the portable accessory 100 has been tampered with or destroyed in some way. In this example, combination lock 4 is configured to contain 4 dials coupled to the exterior posterior side of the combination lock 4. The combination lock 4 may be configured such that the dials of the combination can be on any of the exterior surfaces of combination lock 4. An ordinary person skilled in the art of wearable technology would be aware that the combination dials could be placed on any of the exterior surfaces of the combination lock.

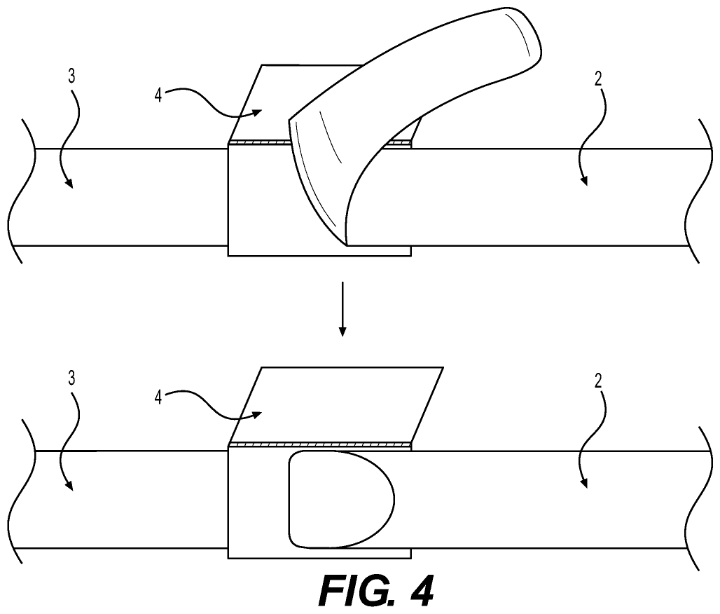

FIG. 4 shows an exemplary embodiment of the combination lock 4 on the set of straps 2 and 3 of the portable accessory 100 configured to adjust the length of one of the straps 2 and 3 by folding it into the combination lock 4. All appendages are different sizes, so there is a need to ensure that the straps 2 and 3 can be lengthened or shortened should that need arise. FIG. 4 shows one exemplary embodiment of the straps 2 and 3 in which they can be shortened. FIG. 4 shows a horizontal exterior and interior view of the straps 2 and 3 as well as combination lock 4. The strap 2 is configured to fold over so that the excess of the band may be locked inside of combination lock 4. FIG. 4 demonstrates how strap 2 can be folded over and locked inside of combination lock 4 such that the excess band does not protrude from combination lock 4. Strap 3 remains the same as previously described and configured. By folding over the strap 2, the excess of strap 2 can be locked inside of the combination lock 4 in any amount that is necessary. This also takes into consideration the growth of an appendage and allows strap 2 to be adjusted as necessary.

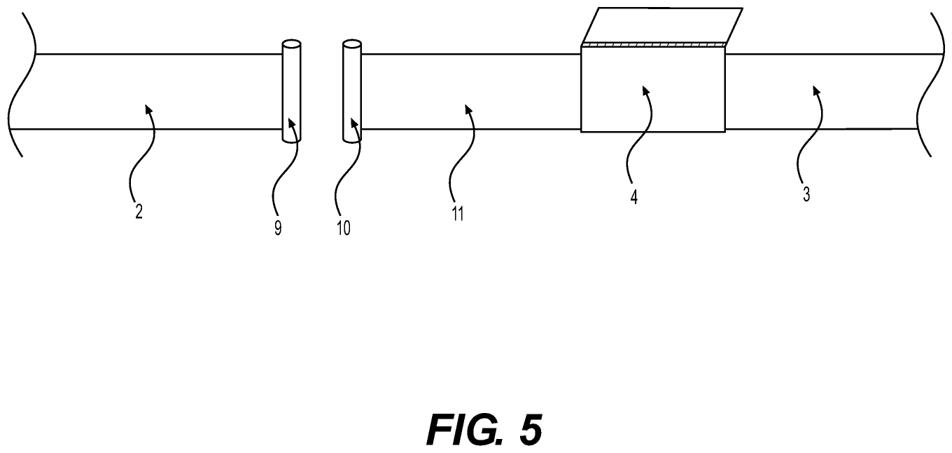

FIG. 5 shows an exemplary embodiment of the combination lock 4 on the set of straps 2 and 3 of the portable accessory 100 configured to adjust the length of one of the straps 2 and 3 through the use of an additional strap 11 and locking mechanism configured to lock into the combination lock 4. On the strap 2, there is a first tube 9 configured to be opened or closed. In one exemplary embodiment, there is a specific device that may be provided with the portable accessory 100 to open and close the tube 9. There is a second strap 11 with a second tube 10 that allows the length of strap 2 to be increased. The tube 9 is configured to be opened and the tube 10 is configured to be placed inside the tube 9 and then the tube 9 may be closed to lock the tube 10 inside of tube 9 such that it cannot be removed without the specific device needed to open the tubes 9 and 10. The opposite end of strap 11 is configured to lock inside of combination lock 4 coupled to strap 3. The tube 9 is further configured to contain a pinhole on either the exterior lateral or exterior medial circular portions of the tube so that a special key may be used to lock or unlock tube 9.

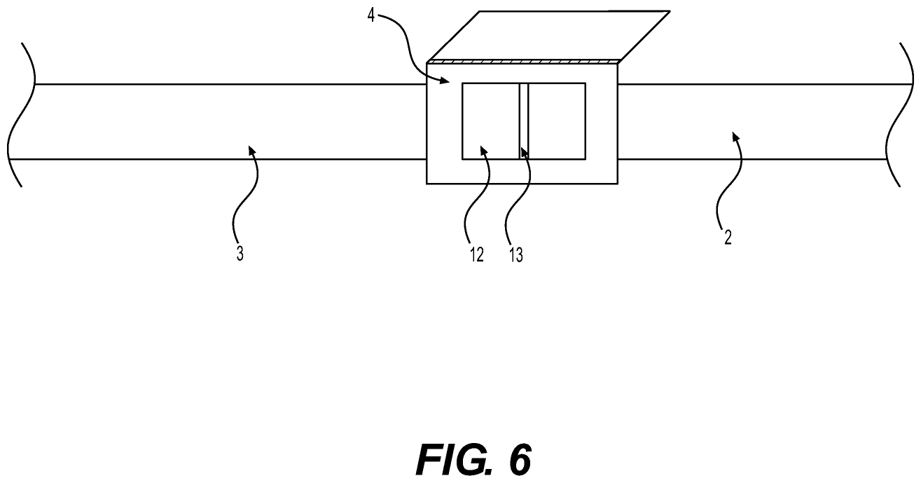

FIG. 6 shows an exemplary embodiment of the combination lock 4 on the set of straps 2 and 3 of the portable accessory 100 configured to adjust the length of one of the straps 2 and 3 through the use of an interior buckle inside the combination lock 4. The interior of combination lock 4 is configured to contain a rectangular piece 12 with a bar 13 connecting the midpoints of the longest sides together. As shown in FIG. 6, the rectangular piece 12 is a frame in which there is an open space on either side of the bar 13. The rectangular piece 12 is further configured to receive the strap 2 such that the strap 2 can be weaved through the open space and around the bar 13. This is similar to that of a backpack strap and allows the strap 2 to be adjusted as needed. The interior buckle may be configured on a hinge that is couple to a first side of the interior of the combination lock 4, which would allow one end of the interior buckle to be lifted out of the combination lock 4 when it is open. The combination lock 4 is configured to be locked with the strap 2 weaved through the rectangular piece 12. The combination lock 4 may be further configured to allow the excess of strap 2 to come out of the combination lock 4 after the strap has been weaved through the rectangular piece 12 and the combination lock 4 is locked.

A unique identification number may be associated with each portable accessory 100. As such, the portable accessories are configured to be individual in nature and no two portable accessories have the same identification number. The unique identification number of the portable accessory is configured to correspond to the mobile application. Once an account is created, the unique identification number can be input into the mobile application so that the portable accessory 100 is linked to the mobile application. The mobile application is configured to allow notifications to be sent through the application if the depressible crown wheel 8 is depressed by a wearer. The notification may include, but is not limited to, the location of the portable accessory and real-time tracking once the depressible crown wheel is depressed. The mobile application is further configured to allow an account holder to activate the GPS chip 14 and/or waterproof speaker 15 on the specific portable accessory associated with the mobile application account.

The materials used to make the straps 2 and 3 may include, but are not limited to, PVC canvas, ripstop canvas, acrylic canvas, denim, graphene, nylon, gore-tex, nomex synthetic rubber and Kevlar. Any material that is considered tear-proof or incredibly sturdy can be used to create the straps.

The materials used to make the housing unit may include, but are not limited to any metals, ceramics, plastics or glass deemed waterproof or sturdy enough to contain the necessary devices listed above. A person who is skilled in the art would recognize the appropriate materials to use or be modified to be used for this housing unit.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A portable accessory, comprising:
a housing unit comprising a waterproof speaker, a global position system tracking chip and an emergency response beacon;
a set of straps made of a tear-proof material, wherein a first end of a first strap is coupled to a first side of the housing unit, a first end of a second strap is coupled to a second side of the housing unit, a second end of the first strap comprises a combination lock and a second end of the second strap is configured to lock into the combination lock; and
a continuous wire within the set of straps that is configured to form a complete circuit that runs through the housing unit and two straps when the set of straps are coupled together,
wherein at least one of the emergency response beacon, the global position tracking chip or the waterproof speaker is configured to be activated based on receiving a signal from a mobile application, and
wherein the portable accessory includes a unique identification number that corresponds to the mobile application.

2. The portable accessory of claim 1, further comprising:
a crown wheel located on an exterior side of the housing unit, wherein the crown wheel is configured to activate one of the emergency response beacon, global position tracking chip or waterproof speaker when the crown wheel is depressed.

3-4. (canceled)

5. The portable accessory of claim 1, wherein the housing unit has a waterproof rating of ISO 6425 or better.

6. The portable accessory of claim 1, further comprising:
a power source located in the housing unit, wherein the power source is one of a rechargeable battery or an automatic chronograph energy source.

7. The portable accessory of claim 1, wherein the second end of the second strap is configured to fold and be locked inside the combination.

8. The portable accessory of claim 1, further comprising:
a third strap comprising a first tube configured to lock into a second tube of the second strap.

9. The portable accessory of claim 1, wherein the combination lock includes a rectangular component having a bar coupled to the midpoints of two sides of the rectangular component, wherein the second end of the second strap is configured to be coupled to the rectangular piece when the combination lock is closed.

10. The portable accessory of claim 1, wherein an exterior anterior side of the housing unit is configured as a working watch.

11. The portable accessory unit of claim 1, wherein the exterior anterior side of the housing unit is configured as an engravable face plate.

12. The portable accessory of claim 1, wherein the continuous wire is configured to carry a signal through the set of straps to and from the housing unit once the set of straps are coupled together.

13. The portable accessory of claim 1, wherein the continuous wire is configured to activate the waterproof speaker when the continuous wire is tampered with or destroyed.

14. The portable accessory of claim 1, wherein the emergency response beacon is configured to transmit an alert to another device with a mobile application associated with a unique identification number corresponding to the portable accessory when the continuous wire is tampered with or destroyed.
